(19) United States
(12) Patent Application Publication
(10) Pub. No.: US 2003/0160158 A1
(43) Pub. Date: Aug. 28, 2003

(54) Raindrop/light beam detecting sensor and auto-wiper device

(76) Inventors: Hirotsugu Ishino, Toyohashi-City (JP); Osamu Terakura, Nagoya-City (JP)

Correspondence Address: POSZ & BETHARDS, PLC, 11250 ROGER BACON DRIVE, SUITE 10, RESTON, VA, 20190, US

(21) Appl. No.: 10/373,965

(22) Filed: Feb. 27, 2003

(30) Foreign Application Priority Data
Feb. 28, 2002 (JP) 2002-054649

(51) Int. Cl. G02B 6/42

(52) U.S. Cl. 250/227.25

(57) ABSTRACT

In an apparatus S, a peripheral light beam detecting light-receiving element 5 is disposed on a substrate 3 carrying a light-emitting element 4 and a light-receiving element 5 for detecting a raindrop. The peripheral light beam detecting light-receiving element 5 and the light receiving element 5 for detecting a raindrop are the same element. A plano-convex lens 10 is disposed so that a convex wall 10a thereof is opposed to the light-receiving element 5; the plano-concave lens 11 is disposed so that a concave wall 11a thereof is opposed to a plane wall 10b of the plano-convex lens 10, and a plane wall 11b of the plano-convex lens 10 is in tight or substantially tight contact with the inside wall 9b of the front windshield 9, whereby the peripheral light beams are collected to the light-receiving element 5 via the plano-concave lens 11 and the plano-convex lens 10.

### BACKGROUND OF THE INVENTION

1. Field of the Invention

The present invention relates to a raindrop/light beam detecting sensor for controlling a wiper, a light or an air-conditioner and an auto-wiper device, which are carried on a vehicle. Particularly, it relates to a raindrop/light beam detecting sensor in which a raindrop detecting sensor, and a light beam detecting sensor are integral with each other in one unit, and an auto-wiper device for controlling a wiper based on detected amounts of rainfall and light.

2. Description of the Related Art

Various raindrop detecting sensors of a light-reflection type have been known in the prior art, comprising a light-emitting element and a light-receiving element wherein a light beam emitted from the light-emitting element is guided to a front windshield (also referred merely to as a front window) via a prism, reflected therefrom, and received to the light-receiving element, to determine a rainfall based on the reduction of an amount of the received light relative to an amount of the emitted light, to output a wiper-controlling signal (for example, see Japanese Unexamined Patent Publication No. 11-83740). Such raindrop detecting sensors are attached to the front window of the vehicle for the purpose of achieving their object. As the light-receiving element for detecting the raindrop is to receive the light beam reflected from the front window via the prism, it is necessary to dispose this element at a position away, by a distance, from the front window.

Also, light beam detecting sensors have variously been known wherein a light-receiving element is provided for detecting peripheral light beams outside the vehicle (including solar radiation) and a control signal for controlling a light or an air-conditioner is output therefrom based on an amount of the received light beam (for example, see U.S. Pat. No. 5,955,726. These light beam detecting sensors are generally attached to a ceiling part of the vehicle.

In this regard, it is required, for combining the raindrop detecting sensor and the light beam detecting sensor with each other, for the sensors to be integral in one unit for the purpose of reducing the number of parts in the unit and to lower the manufacturing cost. Therefore, there has been proposed a raindrop/light beam detecting sensor in which a light-receiving element for detecting the raindrop and another light-receiving element for detecting the peripheral light beams are provided on the same substrate, and that in which a light-receiving element for detecting the raindrop is used also for detecting peripheral light beams as shown in FIG. 9.

In the raindrop and light beam detecting sensor shown in FIG. 9, a substrate 96 is supported within the interior of an inner housing 94 accommodated in an outer housing 95, and carries an amplifier circuit or other devices together with a light-emitting element 97 and a light-receiving element 98. Also, a bottom of a prism 93 is adhered via a transparent adhesive sheet 91 to an inner wall 92b of a vehicle's front window (a wall surface in the compartment side). The light-emitting element 97, the light-receiving element 98 and the prism 93 are arranged so that a light beam emitted from the light-emitting element 97 is reflected from the front window 92 via the prism 93 and received by the light-receiving element 98 via the prism 93 again. In order to cut a horizontal light beam, a slit 99 is formed in the inner housing 94 at a position opposed to the light-receiving element 98, and the light-receiving element 98 is disposed to also receive the peripheral light beams.

A light beam detecting sensor formed to create control signals, in correspondence to a plurality of devices to be controlled such as a light or an air-conditioner, from a photoelectric current generated in one light-receiving element without lowering the S/N ratio has been known as shown in U.S. Pat. No. 5,955,726. This light beam detecting sensor includes a light-receiving element, a current-mirror circuit for creating two kinds of electric currents proportional to the photoelectric current generated in the light-receiving element, a processing circuit for amplifying one of the currents and outputting the same to the air-conditioner controller or others and a processing circuit for converting the other of the currents to frequency signals and outputting the same to the light controller or others.

Also, as an area for detecting raindrops is small in the above raindrop detecting sensor of a light-reflection type, the amount of raindrops attached to the detection surface largely fluctuates. Therefore, if the wiper is controlled to immediately follow this fluctuation, the wiping interval is frequently switched to annoy the driver and deteriorate a comfortable driving feeling. Accordingly, in the auto-wiper device using the raindrop detecting sensor of a light-refection type, the wiper is not immediately stopped/operated or the wiping period is not immediately changed even if the detected rainfall fluctuates, but is controlled, for example, in a time-delay manner wherein the rainfall in the past several control periods which are weighed and added are used together with the rainfall detected at present.

Even a relatively small amount of raindrops adhered to the front window causes glittering, due to the irregular light reflection, at night to disturb a favorable visual field. Accordingly, a method for controlling the auto-wiper is disclosed in Japanese Unexamined Patent Publication No. 60-252044 wherein, when the wiper is automatically controlled in accordance with the rainfall, the wiper is associated with a light beam detecting sensor for detecting the brightness in the peripheral area of a vehicle so that the sensitivity becomes higher at night; that is, the wiping interval becomes shorter at night than in the daytime for the same rainfall.

In the raindrop/light beam detecting sensor shown in FIG. 9, however, as the light-receiving element 98 is provided at a position away from the front window 92, there is a problem in that the visual field angle (light-collecting range) θ1 becomes narrow as shown in FIG. 9 by the interruption of the other components such as a prism 93, an inner housing 94. Such a problem also occurs when a separate light-receiving element for detecting peripheral light beams is provided together with a light-receiving element, for detecting raindrops, on the same substrate. If it is required to obtain the predetermined visual field angle when the light-receiving element for detecting raindrops and that for detecting peripheral light beams are arranged on the same substrate, including a case wherein both the light-receiving elements are common, it is necessary to enlarge a size of the sensor device itself, which may be within the visual field of the driver to disturb the driving operation.

If one wishes to have a plurality of signals in correspondence to a plurality of devices to be controlled from the photoelectric current created by a single light-receiving element through the circuit shown in the above-mentioned Japanese Unexamined Patent Publication No. 10-30960, there is a problem in that a circuit structure becomes complicated to require an exclusive IC and to increase the manufacturing cost.

Also, as described above, as the raindrop detecting sensor of a light-reflection type controls the wiper in a time-delay manner in correspondence to a fluctuation in the rainfall, there is another problem in that the wiper continues the operation for a while at a shorter wiping interval, to annoy the driver, even if the vehicle enters a tunnel. However, the commencement of the wiping operation may be delayed or a considerable time is consumed until the wiping interval becomes shorter when the vehicle leaves the tunnel.

Also, when the sensitivity is uniformly increased at night as in the method disclosed in Japanese Unexamined Patent Publication No. 60-252044, there is a further problem in that the driver feels annoyance because the wiping interval becomes shorter whether or not glittering occurs when there is no car running on the opposite lane or no light is reflected from the road surface.

### SUMMARY OF THE INVENTION

The present invention is to solve the above-mentioned problems, and a first object thereof is to provide a raindrop/light beam detecting sensor in which a raindrop detecting sensor and a light beam detecting sensor are integral with each other in one unit to be small in size.

A second object thereof is to provide a raindrop/light beam detecting sensor, which is simple in circuit structure, by using a single light-receiving element for detecting both raindrops and peripheral light beams, capable of outputting signals in correspondence with a plurality of devices to be controlled while maintaining a favorable S/N ratio.

A third object thereof is to provide an auto-wiper device giving the driver with a favorable feeling during use and capable of carrying out the wiper control in accordance with various situations such as when the vehicle enters or leaves a tunnel or when no car is running on the opposite lane or there is no light reflected from the road surface.

To solve the above problems, a raindrop/light beam detecting sensor according to one aspect of the present invention comprises a substrate on which are arranged a light-emitting element for emitting a light beam to a front wind shield, a raindrop detecting light-receiving element for receiving the light beam emitted from the light-emitting element and reflected by the front wind shield, and a peripheral light beam detecting light-receiving element for receiving peripheral light beams, and a lens means for collecting the peripheral light beams to the peripheral light beam detecting element.

According to this aspect, as the lens means collects the peripheral light beams in the peripheral light beam detecting light-receiving element, it is possible to widen a visual field angle of the peripheral light beam detecting light-receiving element without enlarging a size of the sensor even though the raindrop-detecting light-receiving element and the peripheral light beam detecting light-receiving element are arranged on the same substrate, whereby the raindrop detecting sensor and the light beam detecting sensor are integral with each other in a single small unit.

According to another aspect of the present invention, the lens means comprises a plano-convex lens and a plano-concave lens, wherein the plano-convex lens is disposed so that a convex wall thereof is opposed to the peripheral light beam detecting light-receiving element, the plano-concave lens is disposed so that a concave wall thereof is opposed to a plane wall of the plano-convex lens, and a plane wall of the plano-convex lens is in tight or substantially tight contact with the inside wall of the front wind shield, whereby the peripheral light beams are collected to the peripheral light beam detecting light-receiving element via the plano-concave lens and the plano-convex lens.

In this regard, the tight contact includes a case in which both the walls are brought into contact with each other via an adhesive layer such as an adhesive tape or an adhesive sheet or a solidified adhesive agent. The peripheral light beams include solar beams.

According to this aspect, the peripheral beams are collected through the front window and the plan-concave lens to be parallel beams which are then collected through the plano-convex lens and received by the peripheral light beam detecting light-receiving element. Accordingly, even though the raindrop detecting light-receiving element and the peripheral light beam detecting light-receiving element are disposed on the same substrate, it is possible to widen the visual field angle of the peripheral light beam detecting light-receiving element without enlarging the size of the sensor so that both the raindrop detecting sensor and the light beam detecting sensor are integrated with each other.

A raindrop/light beam detecting sensor according to a further aspect of the present invention has a single light-receiving element common to the raindrop detecting light-receiving element and the peripheral light beam detecting light-receiving element.

According to this aspect, since it is unnecessary to provide the peripheral light beam detecting light-receiving element separate from the raindrop detecting light-receiving element, it is possible to integrate both the raindrop detecting light-receiving element and the light beam detecting light-receiving element with each other to further minimize the size of the sensor and reduce the number of parts.

A raindrop/light beam detecting sensor of a further aspect of the present invention for detecting raindrops and a peripheral light beam and outputting a control signal in accordance with each of a plurality of units to be controlled comprises a light-emitting element for emitting a light beam toward a front windshield, a light-receiving element for receiving a light beam emitted from the light-emitting element and reflected by the front windshield as well as the peripheral light beams, a conversion-amplifier circuit capable of changing a gain in correspondence to the units to be controlled, for converting and amplifying an electric current generated by the light-receiving element to a voltage, an alternate current amplifier circuit connected to the conversion-amplifier circuit, for amplifying an alternate current component of the signal output from the conversion-amplifier circuit, and a control means for changing the gain in accordance with time periods of the gain determined by the time division in the respective unit to be controlled and reading a signal output from the conversion-amplifier circuit or the alternate current amplifier circuit to output a control signal in correspondence to the respective unit to be controlled.

According to this aspect, even if the raindrop detecting sensor and the light beam detecting sensor are integrated with each other by using a single light-receiving element, it is possible to generate control signals in correspondence to a plurality of units to be controlled having a favorable S/N ratio through a simple circuit structure.

In a raindrop/light beam detecting sensor of a still further aspect of the present invention, an operational amplifier is provided in the conversion-amplifier circuit and a feedback resistor section is connected between an output terminal and an input terminal of the operational amplifier, wherein the feedback resistor section is structured by connecting a plurality of resistors in parallel to each other, to each of which resistor is connected a switch, in series, so that the resistor having a resistance in correspondence to each of the units to be controlled is selectable as a feedback resistor by operating the switch to change the gain of the conversion-amplifier circuit.

According to this aspect, it is possible to switch the gain by the control means only by adding a simple circuit composed of a resistor and a switch to generate control signals in correspondence to a plurality of units to be controlled while maintaining a favorable S/N ratio.

An auto-wiper device according to another aspect of the present invention comprises a raindrop detecting means having a light-emitting element for emitting a light beam toward a front wind shield and a raindrop detecting light-receiving element for receiving the light beam emitted from the light-emitting element and reflected by the front wind shield to output a signal in accordance with an amount of light received by the raindrop detecting light-receiving element, and a control means for outputting a signal for controlling a wiper based on a signal output from the raindrop detecting means, wherein the auto-wiper device is adapted so that a signal in correspondence to a receiving signal from GPS (Global Positioning System) is input to the control means which then detects the entrance of a tunnel when receiving the GPS signal is interrupted, while it detects the exit of the tunnel when receiving the GPS signal is recovered, or the auto-wiper device comprises a peripheral light beam detecting means for outputting a signal in accordance with an amount of light received by a peripheral light beam detecting light-receiving element incorporated therein for receiving the peripheral light beams, and a horizontal light detecting means for outputting a signal in correspondence to an amount of a horizontal light beam received by a horizontal light beam receiving element incorporated therein, and is adapted so that the control means detects an entrance of a tunnel when the signal output from the horizontal light beam detecting means satisfies a predetermined reduction condition and the signal output from the peripheral light beam detecting means satisfies a predetermined reduction condition, while the control means detects an exit of the tunnel when the signal output from the horizontal light beam detecting means satisfies a predetermined increase condition and the signal output from the peripheral light beam detecting means satisfies a predetermined increase condition; wherein when the entrance of the tunnel is detected while the wiper is operating, the control means controls the wiper so that the wiping operation is interrupted in a shorter time period than that when the entrance of the tunnel is not detected, and when the exit of the tunnel is detected, the control means controls the wiper so that the wiping interval reaches a value in correspondence with the rainfall in a shorter time period than that when the exit of the tunnel is not detected.

According to this aspect, as the wiping interval is promptly prolonged when the vehicle enters the tunnel to interrupt the wiping operation, while the wiping motion is promptly restarted when coming out the tunnel, it is possible to provide an auto-wiper device favorable in feeling during the use.

An auto-wiper device according to a further aspect of the present invention comprises a raindrop detecting means having a light-emitting element for emitting a light beam toward a front wind shield and a raindrop detecting light-receiving element for receiving the light beam emitted from the light-emitting element and reflected by the front wind shield to output a signal in accordance with an amount of light received by the raindrop detecting element, and a control means for outputting a signal for controlling a wiper based on a signal output from the raindrop detecting means, wherein the auto-wiper device comprises a peripheral light beam detecting means for outputting a signal in accordance with an amount of light received by a peripheral light beam detecting light-receiving element incorporated therein for receiving the peripheral light beams, and a horizontal light detecting means for outputting a signal in correspondence to an amount of a horizontal light beam received by a horizontal light beam receiving element incorporated therein; and when a rainfall determined based on a signal output from the raindrop detecting means satisfies a predetermined condition for operating the wiper and a signal output from the horizontal light beam detecting means satisfies a predetermined condition for putting the light ON as well as when a signal output from the horizontal light beam has a predetermined value or less, the wiping interval of the wiper is prolonged to be longer than that when the rainfall is substantially the same and the signal output from the horizontal light beam detecting means exceeds the predetermined value.

According to this aspect, as the wiping interval is prolonged by detecting the horizontal light beam when there is no vehicle running on the opposite lane and no light reflected from a road surface at night, it is possible to provide an auto-wiper device, favorable in feeling during use, which is free from an annoyance to the driver caused by the useless short wiping interval.

The present invention may be more fully understood from the description of preferred embodiments of the invention, as set forth below, together with the accompanying drawings.

### BRIEF DESCRIPTION OF THE DRAWINGS

In the drawings:

FIG. 1 is a front view of a raindrop/light beam detecting sensor and an auto-wiper according to one embodiment of the present invention;

FIG. 2 is a sectional view taken along a line II-II in FIG. 1;

FIG. 3 is a sectional view taken along a line III-III in FIG. 1;

FIG. 4 is a sectional view taken along a line IV-IV in FIG. 1;

FIG. 5 is a circuitry of the sensor in FIG. 1;

FIG. 6 is a time chart for explaining the operation of the sensor in FIG. 1;

FIG. 7 is an illustration for explaining the operation of the sensor in FIG. 1;

FIG. 8 is an illustration for explaining the operation of the sensor in FIG. 1; and

FIG. 9 is a sectional view of a prior art raindrop and light beam sensor.

### DESCRIPTION OF THE PREFERRED EMBODIMENTS

An apparatus S which is one embodiment of a raindrop/light beam detecting sensor as well as an auto-wiper device according to the present invention will be described below.

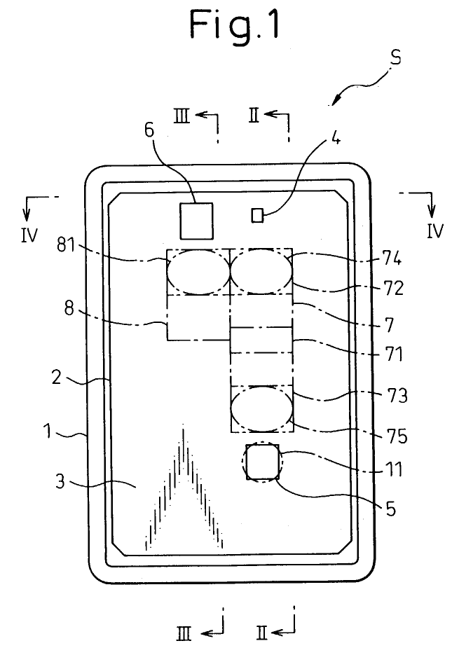

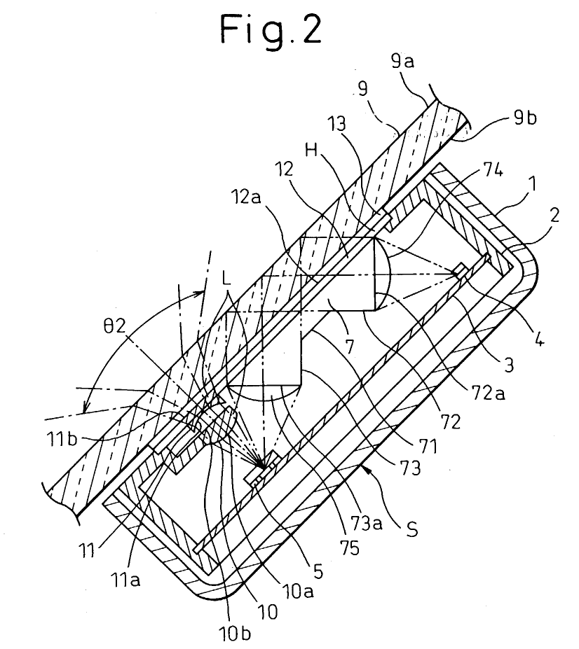

As shown in FIGS. 1 to 4, the apparatus S is provided with an outer housing 1, an inner housing 2 accommodated in the interior of the outer housing 1, a substrate 3 accommodated in the interior of the inner housing 2, a light-emitting element 4, light-receiving elements 5 and 6 attached, respectively, to the substrate 3, a plano-convex lens 10 disposed in front of the light-receiving element 5 and an optical member H disposed in front of the plano-convex lens 10. The optical member H is formed of a transparent resinous material and consists of prisms 7 and 8, a plano-concave lens 11 and a generally rectangular plate member 12. In this regard, in FIG. 1, the prisms 7, 8 and the plano-concave lens 11 are illustrated by a one-dot chain line. The plano-concave lens 10 and the plano-convex lens 11 constitute a lens means L which is illustrated by a hatching in FIG. 2. The light-emitting element 4 is a light-emitting diode (LED) and each of the light-receiving elements 5, 6 is a photo-diode (PD).

Each of the outer housing 1 and the inner housing 2 is of a generally box shape opened in the forward direction. When the apparatus S is attached to the front window 9, the direction toward the front window (upper leftward in FIG. 2) is referred to as the forward direction of the apparatus S and the direction opposite thereto is referred to as the rearward direction thereof. Also, in FIG. 2, the upper rightward direction is referred to as the upward direction of the apparatus S and the lower leftward direction is referred to as the downward direction thereof.

The substrate 3 is held in a rear space of the interior of the inner housing 2. The light-emitting element 4 is mounted to the upper portion of the front surface of the substrate 3 and the light-receiving element 5 is mounted to the lower portion of the front surface of the substrate 3. This light-receiving element 5 is used for detecting both of raindrops and the peripheral light beam. The light-receiving element 6 is also mounted to the upper portion of the front surface of the substrate 3. This light-receiving element 6 is used for detecting a horizontal light beam. In the substrate 3, circuits described later are formed.

The plano-convex lens 10 is disposed at an end of the opening of the inner housing 2 so that a convex surface 10a is opposed to the light-receiving element 5.

As described above, the optical member H is provided with the prisms 7, 8, the plano-concave lens 11 and the plate member 12. The prisms 7, 8 and the plano-concave lens 11 are formed as an integral body and are projected rearward from the plate member 12 while using the same as a common member. That is, a front wall 12a of the plate member 12 forms a front wall of the prisms 7, 8 as well as forms a plane wall 11b of the plano-concave lens 11.

As shown in FIG. 2, the prism 7 has an incident-side light-passage section 72, a refractive-side light-passage section 73, respectively, of a generally triangular prism-shape, and a plate-like light-passage section 71. The incident-side light-passage section 72 is arranged on the upper side of the plate-like light-passage section 71 and the refractive-side light-passage section 73 is arranged on the lower side of the plate-like light-passage section 71 so that they form an integral member defining a rough triangle as seen from a lateral side. Further, the plano-convex lens 74 is formed on a slanted wall 72a of the upper portion of the incident light-passage section 72 to be integral therewith, while the plano-convex lens 75 is formed on a slanted wall 73a of the lower portion of the refractive light-passage section 73 to be integral therewith.

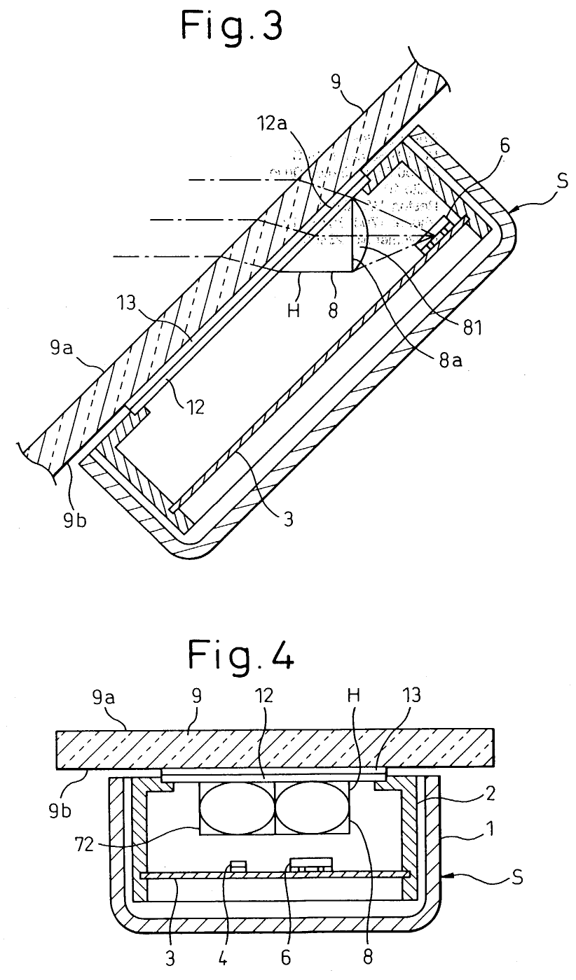

As shown in FIG. 3, the prism 8 is of a generally triangular prism-shape and is arranged adjacent to the incident-side light-passage section 72 to define a rough triangle as seen from a lateral side. A plano-convex lens 81 is formed in the inclined wall 8a on the upper side of the prism 8 so that a plane wall thereof is integral with the inclined wall 8a.

The plano-concave lens 11 has a diameter substantially equal to that of the plano-convex lens 10 and is disposed at a position beneath the plate member 12. A front wall 12a of the plate member 12 is brought into tight contact with an inside wall 9b of the front window 9 via an adhesive sheet 13. That is, the front wall 12a is adhered to the inside wall 9b of the front window 9 while taking care of not leaving air bubbles between the same and the inside wall 9a of the front window 9. Thereby, the front wall of the prism 7, the front wall of the prism 8 and the plane wall 11b of the plano-concave lens 11 are brought into tight contact with the inside wall 9b of the front window 9.

On the other hand, a fastening device not shown is fixed to the periphery of the optical member H in the front window 9 so that the outer housing 1 accommodating the inner housing 2 therein is detachably engaged with the fastening device. Thereby, the optical member H adhered to the inside wall 9b of the front window 9 is covered with the inner housing 2 which is pushed forward by the outer housing 1 by a spring member not shown so that the front surface thereof is brought substantially into tight contact with the inside wall 9b of the front window 9.

As described above, while the optical member H is covered with the inner housing 2, the prism 7 is disposed in a space in front of the light-receiving elements 4 and 5 at a position between the two; the plano-concave lens 11 is disposed at a position in front of the plano-convex lens 10 so that a concave wall 11a is opposed to the plane wall 10b of the plano-convex lens 10; and the prism 8 is disposed at a position obliquely in front of the light-receiving element 6. In this connection, the position of the prism 7 is selected so that a light beam emitted from the light-emitting element 4 is guided thereby, reflected by the front window 9 and collected to the light-receiving element 5 as described later; the position of the prism 8 is selected so that the horizontal light beam is guided thereby and collected to the light-receiving element 6 as described later; and the positions of the plano-concave lens 11 and the plano-convex lens 10 are selected so that the peripheral light beam is guided thereby and collected to the light-receiving element 5 as described later.

The apparatus S thus-structured receives the light beam emitted from the light-emitting element 4, the peripheral light beam and the horizontal light beam as described below.

The light beams emitted from the light-emitting element 4 are incident upon the plano-convex lens 74 as shown by a two-dot chain line in FIG. 2 and converted to parallel light beams which are then incident upon the front window 9 through the incident-side light-passage section 72 and reflected by the outside wall 9a of the front window 9. If there are no raindrops on the front window 9 at that time, the light beams from the light-emitting element 4 are subjected to total reflection. On the other hand, if there are raindrops thereon, the light beams from the light-emitting element 4 are not reflected at a position at which the raindrop exists, but pass to the outside. The light beams reflected from the front window 9 are collected to the light-receiving element 5 by the plano-convex lens 75 through the refractive-side light-passage section 73.

As shown by a one-dot chain line in FIG. 2, the peripheral light beams are incident upon the front window 9 and converted by the plano-convex lens 10 to parallel light beams which are then incident upon the plano-convex lens 10 and collected to the light-receiving element 5. As the plane wall 11b of the plano-concave lens 11 is in tight contact with the inside wall 9b of the front window 9 via the transparent adhesive sheet 13, the plano-concave lens 11 is optically joined to the front window 9. Accordingly, the plano-concave lens 11 and the front window 9 function as a single plano-concave lens capable of collecting the peripheral light beams at a wider visual field angle θ2 as shown in FIG. 2, whereby it is unnecessary to enlarge the size of the apparatus.

The horizontal light beams are incident upon the front window 9 as shown by a one-dot chain line in FIG. 3 and collected to the light-receiving element 6 by the plano-convex lens 81 through the prism 8.

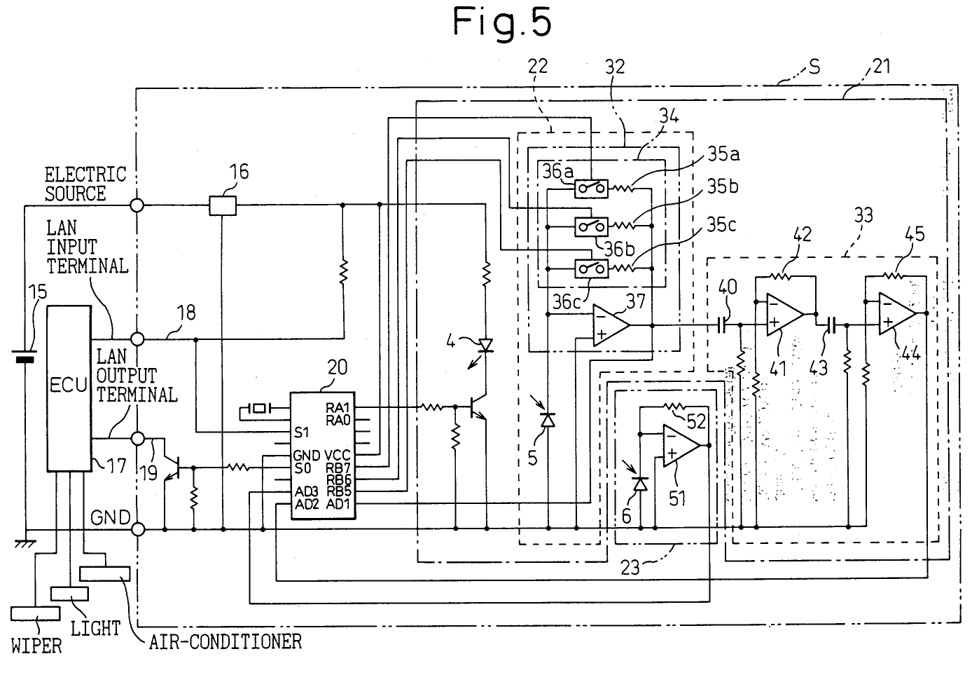

Next, the circuit structure of the apparatus S will be described with reference to FIG. 5. The apparatus S is provided with a control means 20, a raindrop detecting means 21, a peripheral light detecting means 22, and a horizontal light detecting means 23. Also, the apparatus S is provided with a constant-voltage generator 16 connected to an electric source 15.

The control means 20 is a CPU which is connected to the light-emitting element 4 as shown in FIG. 5 to control a drive current for operating the light-emitting element 4 to emit light beams as well as to control the light-emission timing. The control means 20 (hereinafter also referred to as CPU) is connected to various ECUs 17 including a wiper driving unit, a light control unit, an air-conditioner control unit and a GPS receiver unit via a LAN input line 18 and a LAN output line 19. Each of the ECUs 17 is connected to a wiper, a light, an air-conditioner or others, respectively.

The raindrop detecting means 21 is provided with the above-mentioned light-emitting elements 4 and 5 as well as with a conversion amplifier circuit 32 and an alternate current amplifier circuit 33.

The conversion amplifier circuit 32 is provided with an operational amplifier 37 of which the inverted input terminal is connected to a cathode of the light-receiving element 5, and a feedback resistor section 34 connected between an output terminal and the inverted input terminal of the operational amplifier 37. An output terminal of the operational amplifier 37 is connected to a capacitor 40 of the alternate current amplifier circuit 33 and to an input terminal AD1 of the CPU 20.

The feedback resistor section 34 is provided with a resistor 35a and a switch 36a connected in series to the resistor 35a, a resistor 36b and a switch 36b connected in series to the resistor 36a, and a resistor 35c and a switch 36c connected in series to the resistor 35c, wherein these resistors 35a, 35b and 35c connected, respectively, to the switches 36a, 36b and 36c are connected in parallel to each other. Accordingly, a resistance of the feedback resistor section 34 is variable by the ON/OFF operation of the switches 36a, 36b and 36c.

As the larger the resistance of the feedback resistor section 34, the larger a gain (an amplification factor) of the conversion amplifier circuit 32, the resistances of the resistors 35a, 35b and 35c are selected in accordance with units to be controlled as follows.

The resistor 35a is used for controlling a light, and as it is necessary to increase the amplification factor so that a low luminance range such as from 0 to 1 Klx could be detected, a high resistance such as 10 KΩ is selected. The resistor 35b is used for controlling a wiper and, as it is sufficient for detecting a luminance range from 0 to 10 Klx, a medium resistance such as 1 KΩ is selected. The resistor 35c is used for controlling an air-conditioner, and as it is necessary to minimize the amplification factor so that a high luminance range from 1 Mlx to 1 Mlx could be detected, a low resistance such as 100 Ω is selected.

The alternate current amplifier circuit 33 is provided with a capacitor 40, an AC amplifier 41 of which a non-inversion input terminal is connected to the capacitor 40 and a feedback resistor 42 connected between an output terminal and a non-inversion input terminal of the AC amplifier 41. Further, it is provided with a capacitor 43 connected to an output terminal of the AC amplifier 41, an AC amplifier 44 of which a non-inversion input terminal is connected to the capacitor 43, and a feedback resistor 45 connected between an output terminal and a non-inversion input terminal of the AC amplifier 44, so that an alternate current component of the output signal from the conversion-amplifier circuit 32 is amplified at two stages. The output terminal of the AC amplifier 44 is connected to an input terminal AD2 of the CPU 20.

The peripheral light detecting means 22 is provided with the above-mentioned light-receiving element 5 and conversion amplifier circuit 32.

The horizontal light detecting means 23 is provided with the above-mentioned light-receiving element 6, a DC amplifier 51 of which a non-inversion input terminal is connected to a cathode of the light-receiving element 6, and a feedback resistor 52 connected between an output terminal and a non-inversion input terminal. The output terminal of the DC amplifier 51 is connected to an input terminal AD3 of the CPU 20.

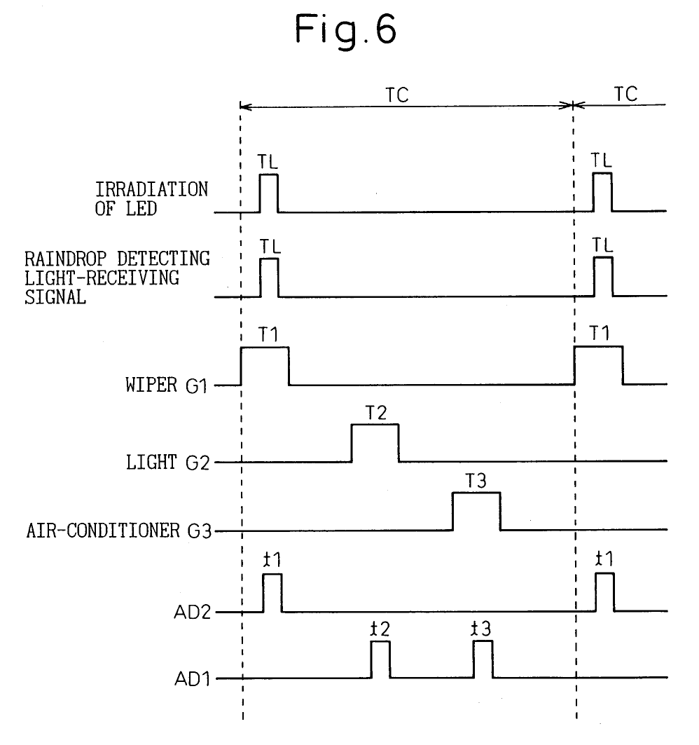

Next, the operation of the apparatus S will be described with reference to a time chart shown in FIG. 6.

In FIG. 6, TC represents a control period and TL represents a timing for operating the light-emitting element 4.

G1 represents a gain when the resistor 35b is selected as a feedback resistor for controlling the wiper; G2 represents a gain when the resistor 35a is selected as a feedback resistor for controlling the light; and G3 represents a gain when the resistor 35c is selected as a feedback resistor for controlling the air-conditioner. T1, T2 and T3 represent set times, respectively, of G1, G2 and G3. The set times T1, T2 and T3 are determined by time division (so that the respective time is not overlapped with another), wherein T1 is determined in correspondence to the light-emission timing TL (that is, to be included in the light-emission timing TL).

Time t1 is a timing at which a signal input to the input terminal AD2 is read, and t2 and t3 are timings at which a signal input to the input terminal AD1 is read. t1 is determined in correspondence to the light-emission timing TL; t2 is determined in correspondence to the set time T2 (that is, to be included in the set time T2); and t3 is determined in correspondence to the set time T3 (that is, to be included in the set time T3).

The operation of the apparatus S will be described below.

When the set time T1 has been reached, CPU 20 turns the switch 36b ON and the switches 36b and 36c OFF, whereby the gain of the conversion amplifier circuit 32 becomes G1 and the light-emitting element 4 emits light beams in pulse shape at the timing TL. The light-receiving element 5 receiving the light beams emitted from the light-emitting element 4 generates an electric current generally proportional to an amount of the received light beams. This electric current is converted to a voltage signal (hereinafter referred to as a rain-detecting light-receiving signal) by the operational amplifier 37 and amplified by the gain G1. In this regard, as the light-emitting element 4 emits light beams in pulse shape at the timing TL, as shown in FIG. 6, the rain-detecting light-receiving signal is also pulsated at the timing TL. The amplified rain-detecting light-receiving signal is input to the alternate current amplifier circuit 33.

In the alternate current amplifier circuit 33, solely the alternate current component of the input rain-detecting light-receiving signal is amplified. The reason therefor is as follows. As the light-receiving element 5 receives the peripheral light beams simultaneously with receiving the light beam from the light-emitting element 4, the rain-detecting light-receiving signal contains a component caused by the peripheral light beams, which component must be removed from the rain-detecting light-receiving signal for the purpose of determining the rainfall. In this regard, as the component derived from the peripheral light beam does not change within an extremely short time period, this component constitutes a direct current component which value is substantially constant. On the other hand, the component derived from the light beam from the light-emitting element 4 constitutes an alternate current component of which the value varies in a pulsing manner.

Accordingly, in the apparatus S, the direct current component of the rain-detecting light-receiving signal is removed by the capacitor 40, and the alternate current component is solely amplified by the AC amplifier 41 and the feedback resistor 42. In the apparatus S, the same processing is repeated by the capacitor 43, the AC amplifier 44 and the feedback resistor 45 in increase the amplification factor of the alternate current component. A signal amplified by the alternate current amplifier circuit 33 (hereinafter referred to as a raindrop detecting signal) is input from the output terminal of the operational amplifier 44 to the input terminal AD2 of the CPU 20.

The CPU 20 reads the raindrop detecting signal input into the input terminal AD2 at the timing t1 and carries out the analog-to-digital conversion. Thus, the CPU 20 determines a rainfall based on the decreased amount of the raindrop detecting signal. In this connection, as the light beam emitted from the light-emitting element 4 passes a portion at which the raindrop is adhered, to outside, it is determined that the larger the decreased amount of the raindrop detecting signal, the larger the rainfall. The CPU 20 determines a wiping interval based on the determined rainfall, the wiper position and the adjusted value of the wiper sensitivity input via the LAN input line 18 and generates a wiper control signal which is output to the wiper drive unit via the LAN output line 19.

In general, the CPU 20 controls the wiper with a time delay (that is, the change of the wiping interval is carried out at a time delay from the variation of the rainfall) by taking not only the instant rainfall but also those in several control periods into consideration. However, as described later, when a tunnel is detected, it controls the wiper either with no time delay or at a shorter time delay than usual. The CPU 20 decides the wiping interval by taking horizontal light beams into consideration at night as described later.

At the set time T2 after passing the set time T1, the CPU 20 turns the switch 36a ON and the switches 36b and 36c OFF so that the gain of the conversion amplifier circuit 32 is G2. As no light beam is emitted from the light-emitting element 4 at the set time T2, the light-receiving element 5 receives solely the peripheral light beams. The electric current generated in the light-receiving element 5 generally in proportional to the received amount of the peripheral light beam is converted to a voltage signal in the conversion amplifier circuit 32 and amplified by the gain G2. This amplified signal (hereinafter referred to as a peripheral light detecting signal for controlling a light) is input to the input terminal AD1 of the CPU 20.

The CPU 20 reads the peripheral light detecting signal for controlling a light input into the input terminal AD1 at the timing t2 and determines an amount of the peripheral light beams (in this case, the brightness in the peripheral area of the vehicle), whereby it generates the light control signal in accordance with the determined brightness and outputs the same to the light control unit via the LAN output line 19.

The CPU 20 turns the switch 36c ON at the set time T3 after passing the set time T2 and the switches 36a and 36b OFF at the set time T3 after passing the set time T2 so that the gain of the conversion amplifier circuit 32 is G3. As no light beam is emitted from the light-emitting element 4 at the set time T3, the light-receiving element 5 receives solely the peripheral light beams. The electric current generated in the light-receiving element 5 generally in proportional to the received amount of the peripheral light beam is converted to a voltage signal in the conversion amplifier circuit 32 and amplified by the gain G3. This amplified signal (hereinafter referred to as a peripheral light detecting signal for controlling an air-conditioner) is input to the input terminal AD1 of the CPU 20.

The CPU 20 reads the peripheral light detecting signal for controlling a light input into the input terminal AD1 at the timing t3 and determines an amount of the peripheral light beams (in this case, the solar radiation), whereby it generates the air-conditioner control signal in accordance with the determined solar radiation and outputs the same to the air-conditioner control unit via the LAN output line 19.

In such a manner, the gain of the conversion amplifier circuit 32 is obtained in correspondence to the unit to be controlled by changing the resistance according to the time division carried out by the CPU 20. Thus, it is possible to obtain signals suitable for a plurality of units to be controlled such as a wiper, a light or an air-conditioner while maintaining a favorable S/N ratio even if a single light-receiving element 5 is used for detecting both of the raindrop and the peripheral light beam.

On the other hand, the light-receiving element 6 receives the horizontal light beam as described before, and the current generated substantially in proportion to the received amount of the horizontal light beam is converted to the voltage signal and amplified by the DC amplifier 51 and the feedback resistor 52. This amplified signal (hereinafter referred to as a horizontal light detecting signal) is input to the input terminal AD3 of the CPU 20. The CPU 20 reads the horizontal light detecting signal input to the input terminal AD3 at a predetermined timing and determines an amount of the horizontal light beam, which is used when the wiping interval of the wiper is determined as described below.

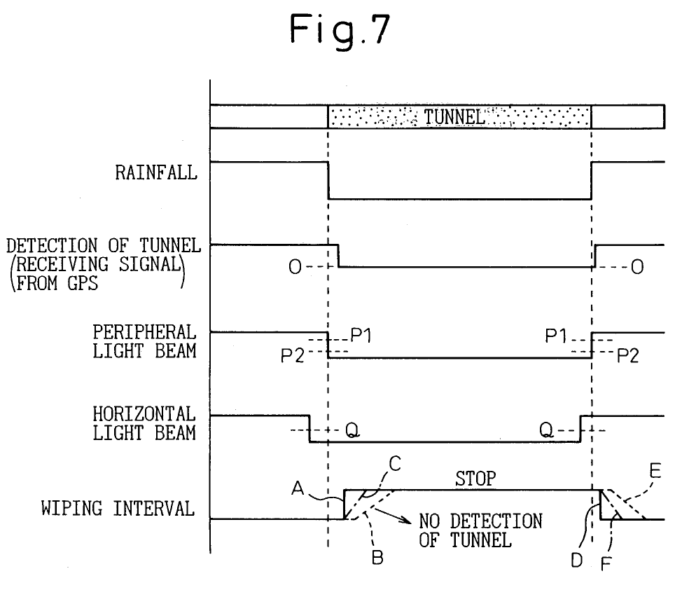

The operation of the apparatus S, when the tunnel is detected, will be described with reference to FIG. 7.

A signal substantially in proportional to the receiving signal from GPS (global positioning system) (hereinafter referred to as a GPS detecting signal) is input to the CPU 20 via the LAN input line 18. When the receiving GPS signal is interrupted, the CPU 20 determines that the vehicle has entered the tunnel (in other words, the entrance of the tunnel is detected). In this regard, the CPU 20 knows the interruption of receiving GPS signal when the GPS detecting signal becomes zero (see 0 in FIG. 7).

When the CPU 20 detects the entrance of the tunnel while the wiper is carrying out the wiping motion, it outputs a wiper control signal for stopping the wiper (see A in FIG. 7). Accordingly, when the vehicle enters the tunnel, the wiper is immediately made to stop. While, if the entrance of the tunnel is not detected, the wiper is gradually made to stop with a time delay as shown by a broken line B in FIG. 7.

When the entrance of the tunnel is detected, the wiper may not be immediately made to stop but may be made to stop after the wiping interval has gradually been prolonged. Even in such a case, the CPU 20 controls the wiper to stop in a shorter time than that when the entrance of the tunnel is not detected (see a one-dot chain line C in FIG. 7).

When the reception of GPS is recovered, the CPU 20 determines that the vehicle has exited the tunnel (that is, the exit of the tunnel is detected). In this regard, the CPU 20 knows the recovery of the reception of GPS by a fact that the GPS detecting signal becomes larger than zero.

When detecting the exit of the tunnel, the CPU 20 outputs a wiper control signal for starting the wiping motion of the wiper at an interval in accordance with a rainfall detected at that instant (see D in FIG. 7). Accordingly, when the vehicle comes outs the tunnel, the wiper immediately starts the wiping motion at an interval in correspondence to the rainfall at that instant. On the other hand, if the exit of the tunnel is not detected, the wiper starts the wiping motion with a time delay as shown by a broken line E in FIG. 7. As the wiping interval is gradually shorter and reaches a value corresponding to the rainfall detected at that instant, the wiping motion of the wiper starts at a shorter wiping interval when the exit of the tunnel is detected than when not detected.

In this regard, if the exit of the tunnel is detected, the wiping motion may not be made to immediately start at a wiping interval in correspondence with the rainfall at that instant, but the wiping interval may be gradually reduced to a value corresponding to the rainfall at that instant. However, even in such a case, the CPU 20 controls the wiper so that the wiping interval reaches a value in accordance with the rainfall at that instant by a shorter time period than that when the exit of the tunnel is not detected (see a one-dot chain line F in FIG. 7).

The detection of the entrance and the exit of the tunnel may be carried out not based on receiving the signal of GPS but on the amount of horizontal and peripheral light beams. That is, when the horizontal light detecting signal and the peripheral light detecting signal are reduced to satisfy a predetermined condition, respectively, it may be determined that there is an entrance of a tunnel; and while when the horizontal light detecting signal and the peripheral light detecting signal are increased to satisfy another predetermined condition, respectively, it may be determined that there is an exit of a tunnel. In this regard, while the peripheral light detecting signal may be that for controlling the air-conditioner, it may be that for controlling the light.

According to this embodiment, the predetermined condition for the reduction of the horizontal light detecting signal is that the horizontal light detecting signal reduces to a predetermined value (see Q in FIG. 7) or lower. This indicates that a space in front of the vehicle is dark. And, the predetermined condition for the reduction of the peripheral light detecting signal is that the peripheral light detecting signal reduces from more than a first predetermined value (see P1 in FIG. 7) to less than a second predetermined value (see P2 in FIG. 7) within a predetermined time period. This indicates that the surroundings of the vehicle becomes suddenly dark. On the other hand, the predetermined condition for the increase in the horizontal light detecting signal is that the horizontal light detecting signal increases to a predetermined value (see Q in FIG. 7) or higher. This indicates that a space in front of the vehicle is bright. The predetermined condition for the increase in the peripheral light detecting signal is that the peripheral light detecting signal increases from less than the second predetermined value (see P2 in FIG. 7) to more than a first predetermined value (see P1 in FIG. 7) within a predetermined time period. This indicates that the surrounding of the vehicle becomes suddenly bright.

As the wiper is immediately made to stop at the entrance of the tunnel and start the wiping motion at the exit in accordance with the rainfall at that instant by the above-mentioned operation of the apparatus S, it is possible to provide an auto-wiper comfortable in feeling during the use.

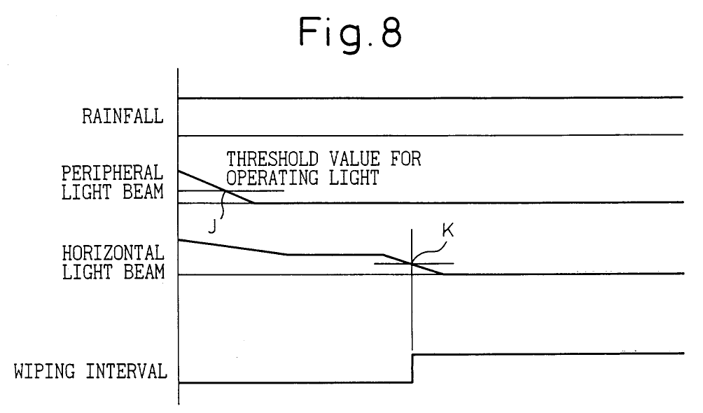

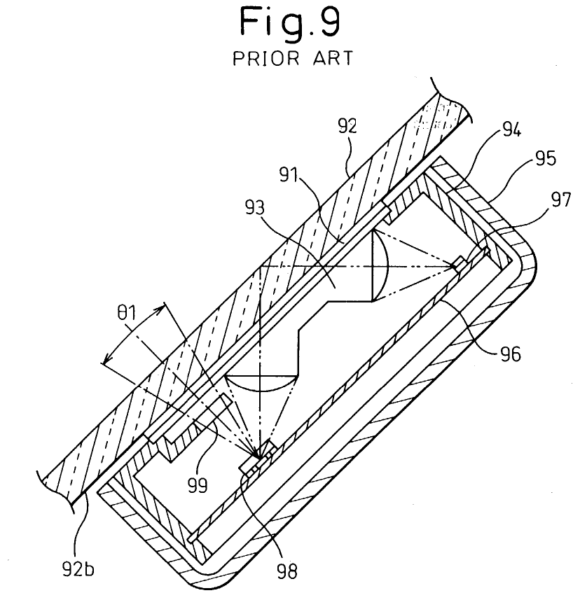

Next, the operation of the apparatus S, when the horizontal light is reduced at night, will be described with reference to FIG. 8.

When the horizontal light detecting signal is less than a predetermined value (see K in FIG. 8), provided the rainfall determined based on the raindrop detecting signal satisfies a predetermined condition for allowing the wiper to operate (that is, the wiper is carrying out the wiping motion) and the peripheral light detecting signal satisfies a predetermined condition for allowing the light to put on (that is, the light is in an ON-state), the wiping interval is prolonged more than that when the rainfall is substantially the same and the horizontal light detecting signal is larger than the predetermined value. This predetermined value is determined based on a horizontal light detecting signal obtained when there is substantially no reflection from a vehicle running on the opposite lane and from a road surface.

In this regard, “the peripheral light detecting signal satisfies a predetermined condition for allowing the light to be put on” means that the peripheral light detecting signal is lower than a predetermined threshold value for putting the light ON (see J in FIG. 8), which also means that the peripheral area of the vehicle is as dark as requiring a light.

“The horizontal light detecting signal is less than a predetermined value” means that there is substantially no light from a vehicle running on the opposite lane or from a road surface. As the front window 9 does not glitter in such a case, the wiping interval is prolonged. Thereby, it is possible to provide a favorable auto-wiper device from which the driver feels no annoyance.

Various criteria or conditions may be adopted when knowing the interruption/recovery of the GPS reception, the reduction/increase of the horizontal and peripheral light beams or determining whether or not the wiper or light is made to operate.

If a resistor having a resistance suitable for a unit to be controlled is provided, the apparatus S is applicable to any unit. For example, the apparatus S is usable for controlling a brightness of a meter other than the operation of a light, a wiper or an air-conditioner.

Also, the circuit structure may be changed. For example, a DC amplifier may be provided between an output terminal of the operational amplifier 37 and an input terminal AD1 of the CPU 20, or the alternate current amplifier circuit 33 may be adapted to operate at a single step (that is, no capacitor 42, AC amplifier 44 and feedback resistor 45 are provided).

The plate member 12 of the optical member H may be in tight contact with the inside wall 9b of the front window 9 not via the adhesive sheet 13 but via a transparent adhesive agent. Also, the plate member 12 is pressed onto the inside wall 9b by a spring member. The plate member 12 may be attached to the inside wall 9b not in a tight contact manner but in a generally tight contact manner.

The prism 7 or others should not be limited to the above-mentioned one but may be that a length of the plate-like light passage section 71 is prolonged in the lengthwise direction of the prism 7, and a reflective plate is provided on a back surface of the plate-like light passage section 71 so that a light beam emitted from the light-emitting element 4 and reflected by the front window 9 is received by the light-receiving element 5 after being reflected from the reflective plate and again reflected from the front window 9. Thereby, the raindrop detecting area is widened.

In the apparatus S, while the light-receiving element 5 is used for detecting both of the raindrop and the peripheral light beam, a separate peripheral light detecting light-receiving element may be provided on the substrate 3 and the plano-convex lens 10 and the plano-concave lens 11 are provided at a position in front of the peripheral light detecting element to collect the peripheral light beams, whereby the light-receiving element 5 is exclusively usable for detecting a raindrop. Even in such an arrangement, the raindrop detecting sensor and the light beam detecting sensor are integral with each other on the same substrate 3 and a visual field angle of the peripheral light detecting light-receiving element can be widened.

The lens means L is not be limited to one in which the plano-convex lens 10 and the plano-concave lens 11 are combined as described above, but may be of any other combinations provided the peripheral light beams could be collected to the light-receiving element 5.

While the invention has been described by reference to specific embodiments chosen for purposes of illustration, it should be apparent that numerous modification could be made thereto by those skilled in the art without departing from the basic concept and scope of the invention.

1. A raindrop/light beam detecting sensor comprising a substrate on which are arranged a light-emitting element for emitting a light beam to a front wind shield, a raindrop detecting light-receiving element for receiving the light beam emitted from the light-emitting element and reflected by the front windshield, and a peripheral light beam detecting light-receiving element for receiving peripheral light beams, and a lens means for collecting the peripheral light beams to the peripheral light beam detecting element.

2. A raindrop/light beam detecting sensor as defined by claim 1, wherein the lens means comprises a plano-convex lens and a plano-concave lens, wherein the plano-convex lens is disposed so that a convex wall thereof is opposed to the peripheral light beam detecting light-receiving element, the plano-concave lens is disposed so that a concave wall thereof is opposed to a plane wall of the plano-convex lens, and a plane wall of the plano-convex lens is in tight or substantially tight contact with the inside wall of the front windshield, whereby the peripheral light beams are collected to the peripheral light beam detecting light-receiving element via the plano-concave lens and the plano-convex lens.

3. A raindrop/light beam detecting sensor as defined by claim 1, wherein a single light-receiving element is used common to the raindrop detecting light-receiving element and the peripheral light beam detecting light-receiving element.

4. A raindrop/light beam detecting sensor for detecting a raindrop and a peripheral light beam and outputting a control signal in accordance with each of a plurality of units to be controlled, comprising a light-emitting element for emitting a light beam toward a front windshield, a light-receiving element for receiving the light beam emitted from the light-emitting element and reflected by the front windshield as well as the peripheral light beams, a converter-amplifier circuit capable of changing a gain in correspondence to the units to be controlled, for converting and amplifying an electric current generated by the light-receiving element to a voltage, an alternate current amplifier circuit connected to the converter-amplifier circuit, for amplifying an alternate current component of the signal output from the converter-amplifier circuit, and a control means for changing the gain in accordance with time periods of the gain determined by the time division in the respective unit to be controlled and reading a signal output from the converter-amplifier circuit or the alternate current amplifier circuit to output a control signal in correspondence to the respective unit to be controlled.

5. A raindrop/light beam detecting sensor as defined by claim 4, wherein an operational amplifier is provided in the converter-amplifier circuit and a feedback resistor section is connected between an output terminal and an input terminal of the operational amplifier, wherein the feedback resistor section is structured by connecting a plurality of resistors in parallel to each other, to each of which resistor is connected a switch in series so that the resistor having a resistance in correspondence to each of the units to be controlled is selectable as a feedback resistor by operating the switch to change the gain of the converter-amplifier circuit.

6. An auto-wiper device comprising a raindrop detecting means having a light-emitting element for emitting a light beam toward a front windshield and a raindrop detecting light-receiving element for receiving the light beam emitted from the light-emitting element and reflected by the front windshield to output a signal in accordance with an amount of light received by the raindrop detecting light-receiving element, and
a control means for outputting a signal for controlling a wiper based on a signal output from the raindrop detecting means, wherein
the auto-wiper device is adapted so that a signal in correspondence to a receiving signal from GPS is input to the control means which then detects the entrance of a tunnel when receiving the GPS signal is interrupted, while it detects the exit of the tunnel when receiving the GPS signal is recovered, or
the auto-wiper device comprises a peripheral light beam detecting means for outputting a signal in accordance with an amount of light received by a peripheral light beam detecting light-receiving element incorporated therein for receiving the peripheral light beams, and a horizontal light detecting means for outputting a signal in correspondence to an amount of a horizontal light beam received by a horizontal light beam receiving element incorporated therein, and is adapted so that the control means detects an entrance of a tunnel when the signal output from the horizontal light beam detecting means satisfies a predetermined reduction condition and the signal output from the peripheral light beam detecting means satisfies a predetermined reduction condition, while the control means detects an exit of the tunnel when the signal output from the horizontal light beam detecting means satisfies a predetermined increase condition and the signal output from the peripheral light beam detecting means satisfies a predetermined increase condition; wherein
when the entrance of the tunnel is detected while the wiper is operating, the control means controls the wiper so that the wiping operation is interrupted in a shorter time period than that when the entrance of the tunnel is not detected, and when the exit of the tunnel is detected, the control means controls the wiper so that the wiping interval reaches a value in correspondence with the rainfall in a shorter time period than that when the exit of the tunnel is not detected.

7. An auto-wiper device comprising a raindrop detecting means having a light-emitting element for emitting a light beam toward a front wind shield and a raindrop detecting light-receiving element for receiving the light beam emitted from the light-emitting element and reflected by the front windshield to output a signal in accordance with an amount of light received by the raindrop detecting light-receiving element, and
a control means for outputting a signal for controlling a wiper based on a signal output from the raindrop detecting means, wherein the auto-wiper device comprises
a peripheral light beam detecting means for outputting a signal in accordance with an amount of light received by a peripheral light beam detecting light-receiving element incorporated therein for receiving the peripheral light beams, and
a horizontal light detecting means for outputting a signal in correspondence to an amount of a horizontal light beam received by a horizontal light beam receiving element incorporated therein; and
when a rainfall determined based on a signal output from the raindrop detecting means satisfies a predetermined condition for operating the wiper and a signal output from the horizontal light beam detecting means satisfies a predetermined condition for putting the light ON as well as when a signal output from the horizontal light beam has a predetermined value or less, the wiping interval of the wiper is prolonged to be longer than that when the rainfall is substantially the same and the signal output from the horizontal light beam detecting means exceeds the predetermined value.
